(19) United States
(12) Patent Application Publication
(10) Pub. No.: US 2003/0221712 A1
(43) Pub. Date: Dec. 4, 2003

(54) Shower tubing for PRS wet bench

(75) Inventors: Shin-Shing Yang, Tainan (TW); Fu-Shiang Chen, Tainan (TW); Juan-Chin Cheng, Tainan (TW); Chih-Hong Cheng, Tainan (TW); Cho-Chin Chen, Tainan (TW)

Correspondence Address: TUNG & ASSOCIATES, 838 W. Long Lake Road, Suite 120, Bloomfield Hills, MI, 48302, US

(73) Assignee: Taiwan Semiconductor Manufacturing Co., Ltd.

(21) Appl. No.: 10/157,283

(22) Filed: May 29, 2002

(51) Int. Cl. B08B 3/02

(52) U.S. Cl. 134/34; 134/199; 134/902

(57) ABSTRACT

Shower tubing which enhances the spray uniformity of deionized water or other rinsing fluid on multiple semiconductor wafers in a wet bench to improve uniformity in the particle-removing capability of the wet bench. Each of a pair of parallel shower tubes in a wet bench cleaning bath is fitted with multiple, closely-adjacent shower nozzles which provide a substantially uniform spray of deionized water or other cleansing or rinsing chemical to all of multiple substrates in the bath.

### FIELD OF THE INVENTION

The present invention relates to processes and equipment for removing potential circuit-contaminating particles from WIP (work-in-process) semiconductor wafers in the semiconductor fabrication industry. More particularly, the present invention relates to shower tubing which enhances the spray uniformity of deionized water or other rinsing fluid on multiple semiconductor wafers during a quick dump rinse cycle in a wet bench to improve uniformity in the particle-removing capability of the wet bench.

### BACKGROUND OF INVENTION

Generally, the process for manufacturing integrated circuits on a silicon wafer substrate typically involves deposition of a thin dielectric or conductive film on the wafer using oxidation or any of a variety of chemical vapor deposition processes; formation of a circuit pattern on a layer of photoresist material by photolithography; placing a photoresist mask layer corresponding to the circuit pattern on the wafer; etching of the circuit pattern in the conductive layer on the wafer; and stripping of the photoresist mask layer from the wafer. Each of these steps, particularly the photoresist stripping step, provides abundant opportunity for organic, metal and other potential circuit-contaminating particles to accumulate on the wafer surface.

In the semiconductor fabrication industry, minimization of particle contamination on semiconductor wafers increases in importance as the integrated circuit devices on the wafers decrease in size. With the reduced size of the devices, a contaminant having a particular size occupies a relatively larger percentage of the available space for circuit elements on the wafer as compared to wafers containing the larger devices of the past. Moreover, the presence of particles in the integrated circuits compromises the functional integrity of the devices in the finished electronic product. Currently, mini-environment based IC manufacturing facilities are equipped to control airborne particles much smaller than 1.0 μm, as surface contamination continues to be of high priority to semiconductor manufacturers. To achieve an ultraclean wafer surface, particles must be removed from the wafer, and particle-removing methods are therefore of utmost importance in the fabrication of semiconductors.

The most common system for cleaning semiconductor wafers during wafer processing includes a series of tanks which contain the necessary cleaning solutions and are positioned in a “wet bench” in a clean room. Batches of wafers are moved in sequence through the tanks, typically by operation of a computer-controlled automated apparatus. Currently, semiconductor manufacturers use wet cleaning processes which may use cleaning agents such as deionized water and/or surfactants. Other wafer-cleaning processes utilize solvents, dry cleaning using high-velocity gas jets, and a megasonic cleaning process, in which very high-frequency sound waves are used to dislodge particles from the wafer surface. Cleaning systems which use deionized (DI) water currently are widely used in the industry because the systems are effective in removing particles from the wafers and are relatively cost-efficient. Approximately 4.5 tons of water are used for the production of each 200-mm, 16-Mbit, DRAM wafer.

A schematic view of a conventional KAIJO (trademark) PRS wet bench cleaning bath, in use, is generally indicated by reference numeral 10 in FIG. 2, and a side view of a typical conventional shower tube for such a wet bench cleaning bath is generally indicated by reference numeral 14 in FIG. 1. The bath interior 12 of the bath 10 contains a pair of the parallel shower tubes 14, each of which includes an elongated shower conduit 16 fitted with multiple, adjacent shower nozzles 18 provided in fluid communication with the shower conduit 16. A conduit nipple 36 typically terminates one end of the shower conduit 16 for connecting the shower conduit 16 to a DI water source (not illustrated). While the schematic of FIG. 2 illustrates only a portion of each shower tube 14, which is shown having only six shower nozzles 18, each conventional shower tube 14 typically includes eleven equally spaced-apart shower nozzles 18, as illustrated in FIG. 1. A wafer boat or other wafer support (not illustrated) which typically holds up to fifty semiconductor wafers 20, 24 is removably contained in the bath interior 12, with the shower nozzles 18 of the respective shower tubes 14 directed toward opposite or diametrically-opposed edge portions of the wafers 20, 24. Each shower nozzle 18 on one of the shower tubes 14 is paired with a corresponding shower nozzle 18 on the other shower tube 14, on respective sides of the wafers 20, 24.

In use, each shower tube 14 is connected to a source (not illustrated) of DI (deionized) water, and in a quick dump rinse cycle, the DI water flows from the shower conduit 16 through the respective shower nozzles 18 at a water flow rate of typically about 10-20 1/min. Each shower nozzle 18 ejects and disperses the DI water toward the wafers 20 in a relatively narrow-angled DI water spray 22, which is bounded by the dashed lines and has the mottled appearance in FIG. 2. Accordingly, the pressurized DI water spray 22 ejected from each shower nozzle 18 is sufficiently wide to flow across the surfaces of typically about four consecutive, vertically-spaced wafers 20, such that the wafers 20 are showered with the DI water spray 22 and potential circuit-contaminating particles (not illustrated) are dislodged and removed from the upper and lower surfaces of the showered wafers 20.

As further illustrated in FIG. 2, one of the limitations inherent in the conventional DI water cleaning bath or system 10 is that the spray nozzles 18 typically fail to spread the DI water spray 22 in a sufficiently wide, divergent cone-shaped spray angle to disperse the DI water spray 22 uniformly along the surfaces of all of the wafers 20, 24 in the bath interior 12. A typical batch of wafers 20, 24 in the bath interior 12 for a quick dump rinse operation includes up to fifty wafers 20, 24, and the total number of shower nozzles 18 is twenty-two (with eleven of the shower nozzles 18 provided on each shower tube 14). Therefore, a typical ratio of wafers:nozzles in the conventional cleaning bath 10 is about 2.2, whereas a maximum wafer:nozzle ratio of about 1.2 is ideal for complete and uniform showering and rinsing of all of the wafers 20, 24 in the bath interior 12. Consequently, some of the wafers, indicated by the reference numeral 20, in the conventional bath 10 are sprayed in a sufficient manner to rinse most or all of the particles from the surfaces of those wafers 20, whereas other wafers, indicated by the reference numeral 24, remain substantially unsprayed by the DI water spray 22 in the conventional cleaning bath 10, and thus, many of the potential wafer-contaminating particles remain on the surfaces of these unshowered wafers 24. Rinsing of the wafers 24 in slots 0, 6, 12, 18 and 24, respectively, of the wafer boat tended to be the poorest in tests conducted.

### SUMMARY OF THE INVENTION

Accordingly, an object of the present invention is to provide a new and improved method and apparatus for cleaning particles from substrates.

Another object of the present invention is to provide a method and apparatus for uniformly washing or rinsing particles from all of multiple substrates.

Still another object of the present invention is to provide shower tubes fitted with multiple shower nozzles for uniformly spraying and rinsing multiple substrates in a wet bench cleaning bath.

Yet another object of the present invention is to provide shower tubes having multiple shower nozzles for spraying DI water on multiple semiconductor wafers, wherein the ratio of wafers:spray nozzles does not exceed the range of from about 1.1 to about 1.5.

A still further object of the present invention is to provide a wet bench cleaning bath which includes at least two shower tubes each fitted with multiple shower nozzles for spraying DI water on multiple semiconductor wafers and rinsing potential circuit-contaminating particles from the wafers.

Yet another object of the present invention is to provide shower tubes for a semiconductor wafer processing wet bench, which shower tubes are capable of thoroughly spraying and rinsing each semiconductor wafer in a wet bench cleaning bath with equal efficacy.

In accordance with these and other objects and advantages, the present invention comprises shower tubing which enhances the spray uniformity of deionized water or other rinsing fluid on multiple semiconductor wafers in a wet bench to improve uniformity in the particle-removing capability of the wet bench. Each of a pair of parallel shower tubes in a wet bench cleaning bath is fitted with multiple, closely-adjacent shower nozzles which provide a substantially uniform spray of deionized water or other cleansing or rinsing chemical to all of multiple substrates in the bath.

### BRIEF DESCRIPTION OF THE DRAWINGS

The invention will now be described, by way of example, with reference to the accompanying drawings, in which:

FIG. 1 is a side view of a typical conventional shower tube used in a conventional wet bench cleaning bath;

FIG. 2 is a schematic view of a typical conventional wet bench cleaning bath, with multiple substrates shown being incompletely and non-uniformly rinsed in the bath;

FIG. 3 is a side view of an illustrative embodiment of a shower tube of the present invention;

FIG. 4 is a schematic view of a wet bench cleaning bath, utilizing a pair of the shower tubes of the present invention illustrated in the singular in FIG. 3, with all of multiple substrates shown being uniformly rinsed in the bath;

FIG. 5 is a graph illustrating average numbers of particles remaining on substrates after three rinsing cycles using the wet bench cleaning bath with the conventional shower tubes, as compared to using the wet bench cleaning bath with the shower tubes of the present invention; and

FIG. 6 is a cross-sectional view, taken along section lines 6-6 in FIG. 3.

### DESCRIPTION OF THE PREFERRED EMBODIMENTS

The present invention has particularly beneficial utility in providing a uniform spray pattern for rinsing semiconductor wafers in wet bench cleaning baths. However, the invention is not so limited in application, and while references may be made to such wet bench cleaning baths, the invention may have utility in a variety of other industrial and mechanical applications.

Referring initially to FIGS. 3, 4 and 6 of the drawings, the present invention includes a pair of shower tubes 34 that are installed in a bath interior 32 of a wet bench cleaning bath 30, which may be a part of a conventional wet bench semiconductor wafer processing system such as a KAIJO (trademark) PRS (photoresist strip) wet bench. Each shower tube 34 typically includes an elongated shower conduit 16, typically fitted with a conduit nipple 36 for connection to a DI water source (not illustrated), in conventional fashion. Multiple shower nozzles 18 extend from the shower conduit 16 in closely-spaced, adjacent relationship to each other.

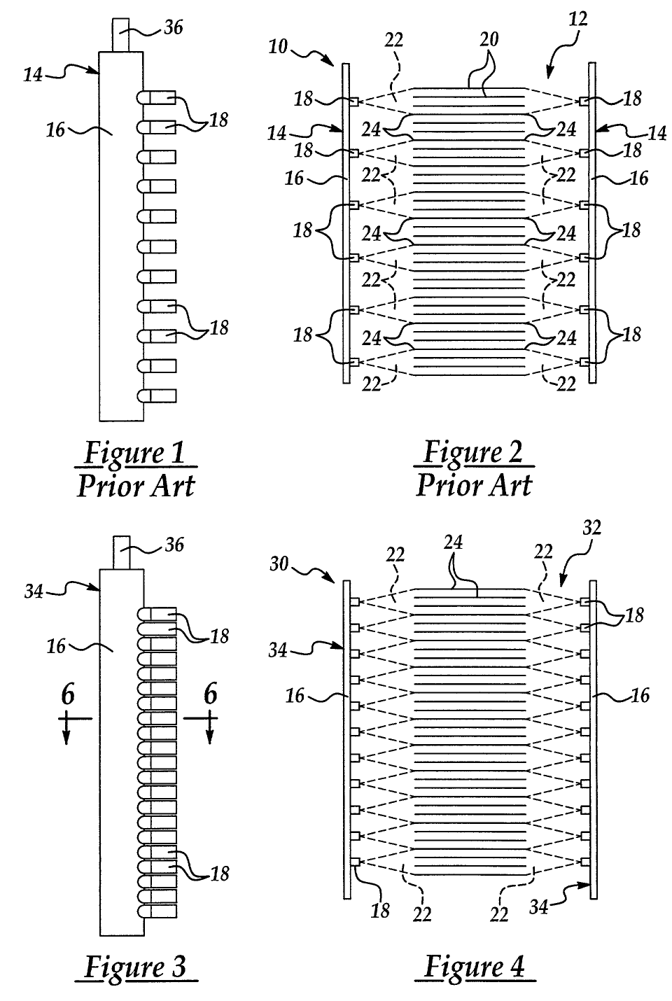

As illustrated in the cross-section of FIG. 6, the shower conduit 16 of each shower tube 34 is traversed by a conduit lumen 42, and each shower nozzle 18 communicates with the conduit lumen 42 through a conduit opening 44. A nozzle opening 40 is provided in the extending end of each shower nozzle 18. It is understood that the shower nozzles 18 of each shower tube 34 of the present invention may have the same design as the shower nozzles 18 of the conventional shower tubes 14 heretofore described with respect to FIG. 1. Alternatively, the shower nozzles 18 may have any other configuration capable of spraying DI water from each shower nozzle 18 in a divergent configuration, as hereinafter described.

As illustrated in FIG. 3, the shower conduit 16 of each shower tube 34 is typically provided with twenty-one shower nozzles 18, for a total of forty-two shower nozzles 18 in the bath interior 32 of the wet bench cleaning bath 30. In operation of the wet bench cleaning bath 30 as hereinafter described, up to fifty semiconductor wafers 20 are positioned in a wafer boat (not illustrated) through respective slots (not illustrated) in the wafer boat, and the wafer boat is placed in the bath interior 32. In that case, the ratio of wafers: shower nozzles would at most be about 1.2, or 50/42, since the maximum number of wafers to be rinsed in the bath interior 32 is fifty. However, it is understood that the ratio of wafers: shower nozzles may be as high as about 1.5 to obtain satisfactory rinsing results.

Referring next to FIG. 4, in typical rinsing or particle-removing operation in a quick dump rinse (QDR) bath application of the wet bench cleaning bath 30 in accordance with the present invention, a wafer boat (not illustrated) containing up to fifty semiconductor wafers 20 in respective slots (not illustrated) of the wafer boat are initially placed in the bath interior 32 of the wet bench cleaning bath 30. A conventional DI water source (not illustrated), connected to the conduit nipple 36 of each shower tube 34, is next operated to force DI water at a water flow rate of from about 15 1/min. to about 20 1/min., and preferably, at a rate of greater than about 20 1/min., through the conduit lumen 42 and the conduit opening 44 and nozzle opening 40, respectively, of each shower nozzle 18 of each shower tube 34. The pressurized DI water leaves each shower nozzle 18 in a diverging, cone-shaped configuration to define a DI water spray 22, in conventional fashion. Accordingly, the DI water sprays 22 formed by each pair of shower nozzles 18 that are disposed in facing relationship to each other on the respective opposing shower tubes 34 flow toward each other and completely cover both the upper and lower surfaces of each wafer 20. As a result, the flowing DI water in the DI water sprays 22 dislodges and removes all or most potential circuit-contaminating particles (not illustrated) from both the lower and upper surfaces of each wafer 20. The DI water from the DI water sprays 22, along with the particles (not illustrated) removed from the wafers 20, conventinally drops from the wafers 20 and into a drain (not illustrated) provided in the bottom of the bath interior 12.

Due to the relatively close proximity of the shower nozzles 18 to each other on the shower conduit 16 of each shower tube 34, the diverging or cone-shaped DI water spray 22 formed by each shower nozzle 18 tends to overlap with the DI water spray 22 formed by the adjacent shower nozzle 18 on the same shower tube 34, and the DI water spray 22 of each shower nozzle 18 is typically capable of spraying about four or five wafers 20. Consequently, both the lower and upper surfaces of all of the wafers 20 in the bath interior 32 are thoroughly and completely showered and rinsed by the DI water sprays 22. The rinsing procedure is performed for typically about 5-20 minutes, after which time most or all of the potential circuit-contaminating particles have been removed from each of the wafers 20.

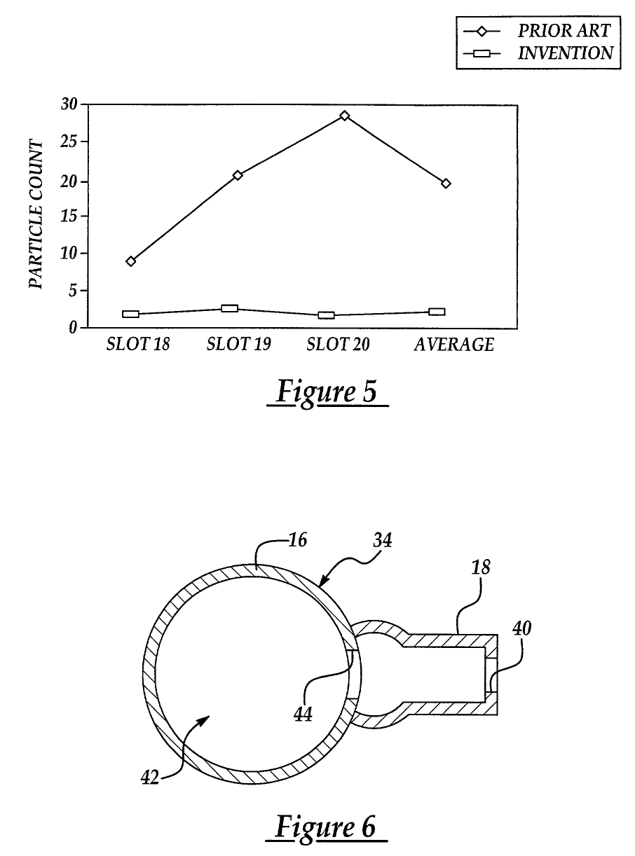

FIG. 5 illustrates a graph which contrasts the average number of particles remaining on three separate wafers in adjacent slots on a wafer boat after a quick dump and rinse cycle using the conventional wet bench cleaning bath 10 having the conventional shower tubes 14, with the average number of particles remaining on the three wafers in the same respective slots after a quick dump and rinse cycle using the wet bench cleaning bath 30 having the shower tubes 34 of the present invention. The data was obtained using the average number of particles remaining on the wafers contained in slots 18, 19 and 20, respectively, of the wafer boat after three separate trials. Accordingly, the particle count remaining after quick dump and rinse using the conventional bath 10 is represented by the line-connected diamonds, whereas the particle count remaining after quick dump and rinse using the bath 30 of the present invention is represented by the line-connected rectangles.

The graph indicates that the average particle count for the wafers contained in slots 18, 19 and 20 after quick dump and rinse using the conventional bath 10 were 8.7, 21, and 28.3, respectively, and the average particle count for those averages was 19.3. In contrast, the average particle count for the wafers contained in slots 18, 19 and 20 after quick dump and rinse using the bath 30 of the present invention were 1.7, 2.7, and 1.7, respectively, and the average particle count for those averages was 2.0. From the graph, it can be seen that decreasing the ratio of wafers:shower nozzles from about 2.2 to about 1.1 increases particle-removing efficacy by a factor of from at least 5 and in some cases, 16.

While the preferred embodiments of the invention have been described above, it will be recognized and understood that various modifications can be made in the invention and the appended claims are intended to cover all such modifications which may fall within the spirit and scope of the invention.

Having described my invention with the particularity set forth above, we claim:

What is claimed is:

1. A method of rinsing a selected number of substrates, comprising:
providing a bath comprising a bath interior;
providing a pair of shower tubes comprising a selected number of shower nozzles in said bath interior;
providing said selected number of substrates in said bath interior between said pair of shower tubes;
ejecting a spray of fluid from said shower nozzles, respectively, and onto said substrates at a selected flow rate; and
wherein a ratio of said selected number of substrates to said selected number of shower nozzles is at most about 1.5.

2. The method of claim 1 wherein said selected number of shower nozzles comprises twenty-one shower nozzles on each of said pair of shower tubes.

3. The method of claim 1 wherein said ratio is from about 1.1 to about 1.5.

4. The method of claim 3 wherein said selected number of shower nozzles comprises twenty-one shower nozzles on each of said pair of shower tubes.

5. The method of claim 1 wherein said selected flow rate is at least about 15 liters/minute.

6. The method of claim 5 wherein said selected number of shower nozzles comprises twenty-one shower nozzles on each of said pair of shower tubes.

7. The method of claim 5 wherein said ratio is from about 1.1 to about 1.5.

8. The method of claim 7 wherein said selected number of shower nozzles comprises twenty-one shower nozzles on each of said pair of shower tubes.

9. The method of claim 2 wherein said ratio is at most about 1.2.

10. The method of claim 9 wherein said selected number of shower nozzles comprises twenty-one shower nozzles on each of said pair of shower tubes.

11. The method of claim 9 wherein said selected flow rate is at least about 15 liters/minute.

12. The method of claim 11 wherein said selected number of shower nozzles comprises twenty-one shower nozzles on each of said pair of shower tubes.

13. The method of claim 5 wherein said selected flow rate is greater than 20 liters/minute.

14. The method of claim 13 wherein said selected number of shower nozzles comprises twenty-one shower nozzles on each of said pair of shower tubes.

15. The method of claim 13 wherein said ratio is at most about 1.2.

16. The method of claim 15 wherein said selected number of shower nozzles comprises twenty-one shower nozzles on each of said pair of shower tubes.

17. A wet bench cleaning bath for rinsing a selected number of substrates, comprising:
a bath interior for receiving the substrates;
a pair of shower tubes provided in said bath interior for receiving a supply of a fluid, respectively;
a selected number of shower nozzles provided on said pair of shower tubes for spraying said fluid against the substrates;
a selected number of substrates removably provided in said bath interior; and
wherein a ratio of said selected number of substrates in said bath interior to said selected number of shower nozzles is at most about 1.5.

18. The wet bench of claim 17 wherein said ratio is from about 1.2 to about 1.5.

19. The wet bench of claim 18 wherein said ratio is at most about 1.2.

20. A shower tube for a wet bench cleaning bath, comprising:
an elongated shower conduit having a conduit interior; and
about twenty-one shower nozzles provided on said shower conduit in fluid communication with said conduit interior.
